(19) United States
(12) Patent Application Publication
(10) Pub. No.: US 2016/0034835 A1
(43) Pub. Date: Feb. 4, 2016

(54) FUTURE CLOUD RESOURCE USAGE COST MANAGEMENT

(71) Applicant: Hewlett-Packard Development Company, L.P., Houston, TX (US)

(72) Inventors: Efrat Egozi LEVI, Yehud (IL); Ira COHEN, Modiin (IL); Ran LEVI, Yehud (IL); Sigalit SADE, Yehud (IL)

(21) Appl. No.: 14/448,729

(22) Filed: Jul. 31, 2014

(51) Int. Cl. G06Q 10/06; H04L 29/08

(52) U.S. Cl. CPC G06Q 10/06313; H04L 67/10

(57) ABSTRACT

According to an example, a history of usage and a history of utilization of resources may be accessed. A usage regression model to predict a cloud resource usage and a utilization regression model to predict a cloud resource utilization at a future time period may be developed. The usage regression model and the utilization regression model may be used to manage cloud resource usage costs.

### BACKGROUND

Cloud computing is becoming a default part of the information technology (IT) landscape as more and more organizations are relying on cloud computing for processes such as storage, business continuity, disaster recovery, and security. As a result, a large number of service providers now offer cloud computing services. In addition, cloud computing service providers typically offer large numbers of resource and pricing combinations, such that different combinations have dramatically different pricing dependent upon usage. As such, organizations have a large number of cloud computing service providers and services from which to receive cloud computing services.

### BRIEF DESCRIPTION OF THE DRAWINGS

Features of the present disclosure are illustrated by way of example and not limited in the following figure(s), in which like numerals indicate like elements, in which:

FIG. 1 is a simplified schematic diagram of a cloud computing environment, in which various aspects of the methods disclosed herein may be implemented, according to an example of the present disclosure;

FIG. 2 is a simplified block diagram of a computing device including a cloud resource usage cost management apparatus depicted in FIG. 1, according to an example of the present disclosure;

FIGS. 3 and 4, respectively, depict flow diagrams of methods for predicting future resource requirements, according to an example of the present disclosure; and

FIG. 5 is schematic representation of a computing device, which may be employed to perform various functions of the computing device depicted in FIG. 2, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the terms “a” and “an” are intended to denote at least one of a particular element, the term “includes” means includes but not limited to, the term “including” means including but not limited to, and the term “based on” means based at least in part on.

As discussed above, there are a large number of cloud computing services providers and services from those providers from which entities, such as organizations, businesses, etc., may select to receive cloud-based services. Because of these large numbers of options, entities may find it difficult to determine which of the cloud computing services providers and the services, e.g., service plans, may result in optimized costs to the entities. The optimized costs may be defined as the minimized costs corresponding to the entities receiving the amount of resources, e.g., usage and utilization, that they require. Thus, for instance, a cost to an entity may not be optimized if there is a lower cost option that results in the entity receiving the same amount or more of the resources from a cloud computing services provider. As another example, a cost to an entity may not be optimized if the cost corresponds to an amount of resources that is higher than the entity requires.

One reason for the difficulties that may arise may be that the entities may not be able to determine, with a desired level of accuracy, what the resource needs of the entities will be at different time periods in the future. As such, the entities may not be able determine which of the service plans offered by a cloud computing services provider or providers, the entities should select for a future time period. Disclosed herein are methods for future cloud resource usage cost management based upon a prediction of cloud resource usage at a future time. Also disclosed herein are apparatuses for implementing the methods. As discussed in greater detail below, the methods disclosed herein may overcome many of the difficulties faced by entities in optimizing costs associated with receipt of cloud-based services from a cloud computing services provider. In the methods, a history of usage of a plurality of resources may be accessed. In addition, a history of utilization of the plurality of resources may also be accessed. Based upon the history of usage, a usage regression model that is to predict a cloud resource usage at a future time period may be developed. Moreover, based upon the history of utilization, a utilization regression model that is to predict a cloud resource utilization for each of a plurality of utilization variable/resource pairs at the future time period may be developed.

Additionally, a future cloud resource usage cost may be managed based upon the usage regression model and the utilization regression model. The management of the future cloud resource usage cost may include a determination of a cost optimization recommendation based upon a predicted cloud resource usage and a predicted cloud resource utilization at the future time period. The cost optimization recommendation may include a recommendation to use a particular service plan offered by a cloud computing services provider, in which the particular service plan corresponds to a service plan that meets an entity's requirements while minimizing cost. In addition, a plurality of cost optimization recommendations may be determined for multiple future time periods. Confidence measures for each of the cost optimization recommendations may also be determined. In addition, scores corresponding to the determined confidence measures may be determined and the scores may be ranked such that a user may identify, for instance, the cost optimization recommendations having acceptable levels of accuracy at a future time period. The user may also identify a preferred cost optimization recommendation.

Through implementation of the methods disclosed herein, future cloud resource usage may accurately be predicted and used to manage costs associated with using the cloud resources. The prediction of the future resource usage may be relatively more accurate than conventional prediction techniques because the predictions disclosed herein use regression models that are trained using time-related features and thus are based upon predicted future usage trends and cost trends. In contrast, conventional prediction techniques rely on an analysis of past and present status while making an implicit assumption that what is being used today will not change in the future.

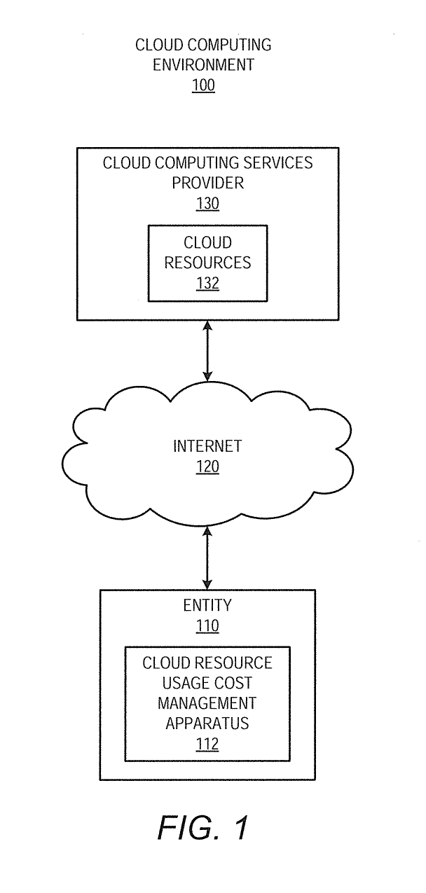

With reference first to FIG. 1, there is shown a simplified diagram of a cloud computing environment 100, on which may various aspects of the methods disclosed herein may be implemented, according to an example. It should be understood that the cloud computing environment 100 depicted in FIG. 1 may include additional elements and that some of the elements depicted therein may be removed and/or modified without departing from a scope of the cloud computing environment 100. For instance, the cloud computing environment 100 may include any number of entities and cloud computing services providers.

As shown in FIG. 1, the cloud computing environment 100 may include an entity 110, the Internet 120, and a cloud computing services provider 130. The entity 110 may communicate data to and receive data from the cloud computing services provider 130 through the Internet 120. The entity 110 may be an individual computer, a business, an organization, etc., that may employ the cloud computing services provider 130 to provide cloud resources 132 to the entity 110. The cloud resources 132 may include, for instance, data storage, data processing, graphics rendering, database services, etc., that are provided over the Internet 120. By way of example, the cloud computing services provider 130 may be a commercial cloud services provider and may charge the entity 110 for the cloud resources 132 that the cloud computing services provider 130 provides to the entity 110. For instance, the cloud computing services provider 130 may charge the entity 110 varying amounts for services depending upon the usage and utilization of the cloud resources 132 by the entity 110. The cloud resources 132 may be, for instance, any of servers, disk space, network bandwidth. I/O calls, etc., that the cloud computing services provider 130 may provide to the entity 110.

The cloud computing services provider 130 may also offer different pricing plans for different cloud resource 132 usages and utilizations. For instance, the cloud computing services provider 130 may offer plans that enable the entity 110 to pay for cloud resource 132 usage as the entity 110 uses those cloud resources 132 under a “pay as you use” pricing scheme. The cloud computing services provider 130 may also offer plans that include discounts if the entity 110 reserves cloud resources 132 at a future date. For instance, the cloud computing services provider 130 may offer plans for the same cloud resources 132 that differ in price for different term lengths. By way of example, a particular service may be less expensive if the entity 110 agrees to purchase that service for a longer period of time. Thus, in certain instances, the entity 110 may reduce or minimize costs associated with using the cloud resources 132 offered by the cloud computing services provider 130 by agreeing to reserve a selected cloud resource or resources 132 for a relatively longer period of time. However, the entity 110 may not have an accurate identification of the cloud resources 132 that the entity 110 may need in the future and the accuracy may decline the further in the future the entity 110 looks.

According to an example, the entity 110 may employ a cloud resource usage cost management apparatus 112 that is to manage cloud resource costs based upon a prediction of future cloud resource requirements, for instance, of the entity 110. Particularly, the cloud resource usage cost management apparatus 112 may predict a cloud resource usage and a cloud resource utilization by the entity 110 at a future time period. The cloud resource usage cost management apparatus 112 may also make these predictions for multiple future time periods. As discussed in greater detail herein, the cloud resource usage cost management apparatus 112 may make these predictions through the development of regression models that may be used to predict future resource usage and resource utilization at multiple periods of time. The regression models may be developed, e.g., trained, learned, etc., using a multiple number of features and inputs, which may include time-related features. In one regard, through use of the time-related features to create a prediction, a trend over a period of time, e.g., based on month, year, etc., may be created. In addition, the trends may be used to determine the future cloud resource requirements of the entity 110. Moreover, the future cloud resource requirements may be compared with multiple cloud resource and pricing schemes to identify which of those schemes meets the future cloud resource requirements at the lowest cost to the entity 110. A user may manage future cloud resource usage cost based upon the identified cloud resource and pricing schemes.

In other words, the cloud resource usage cost management apparatus 112 may manage a future cloud resource usage cost based upon the developed usage regression model and the developed utilization regression model. According to an example, the cloud resource usage cost management apparatus 112 may manage the future cloud resource usage cost by determining a cost optimization recommendation for the entity 110, in which the cost optimization recommendation may identify the usage and utilization of cloud resources 132 that meet the entity's 110 future requirements while minimizing cost to the entity 110. The cloud resource usage cost management apparatus 112 may further determine confidence measures for each of a plurality of cost optimization recommendations at a plurality of future time periods to thus enable a user to determine, for instance, which of the cost optimization recommendations has the highest possibility of being accurate.

Although the cloud resource usage cost management apparatus 112 has been depicted as being part of the entity 110, it should be understood that the cloud resource usage cost management apparatus 112 may be separate from the entity 110. For instance, the cloud resource usage cost management apparatus 112 may be contained in a separate entity and may provide future cloud resource requirement prediction services to the entity 110.

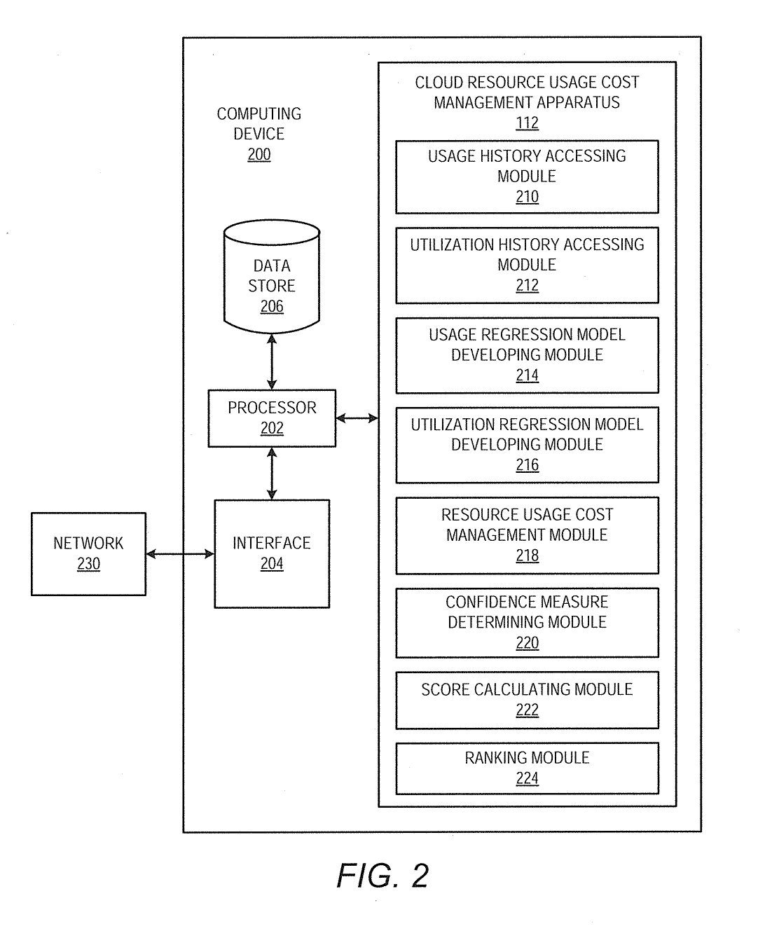

Turning now to FIG. 2, there is shown a simplified block diagram of a computing device 200, according to an example. It should be understood that the computing device 200 depicted in FIG. 2 may include additional elements and that some of the elements depicted therein may be removed and/or modified without departing from a scope of the computing device 200. The computing device 200 may be part of the entity 110 depicted in FIG. 1, e.g., a computer, a server, etc., of the entity 110. Alternatively, the computing device 200 may be part of another entity that is separate from the entity 110 depicted in FIG. 1, such as an entity that provides services for the entity 110.

As shown in FIG. 2, the computing device 200 is depicted as including, in addition to the cloud resource usage cost management apparatus 112, a processor 202, an interface 204, and a data store 206. The cloud resource usage cost management apparatus 112 is also depicted as including a usage history accessing module 210, a utilization history accessing module 212, a usage regression model developing module 214, a utilization regression model developing module 216, a resource usage cost management module 218, a confidence measure determining module 220, a score calculating module 222, and a ranking module 224.

The processor 202, which may be a microprocessor, a micro-controller, an application specific integrated circuit (ASIC), or the like, is to perform various processing functions in the computing device 200. The processing functions may include invoking or implementing the cloud resource usage cost management apparatus 112 and particularly, the modules 210-224 of the cloud resource usage cost management apparatus 112, as discussed in greater detail herein below. According to an example, the cloud resource usage cost management apparatus 112 is a hardware device on which is stored various sets of machine readable instructions. The cloud resource usage cost management apparatus 112 may be, for instance, a volatile or non-volatile memory, such as dynamic random access memory (DRAM), electrically erasable programmable read-only memory (EEPROM), magnetoresistive random access memory (MRAM), memristor, flash memory, floppy disk, a compact disc read only memory (CD-ROM), a digital video disc read only memory (DVD-ROM), or other optical or magnetic media, and the like, on which software may be stored. In this example, the modules 210-224 may be software modules, e.g., sets of machine readable instructions, stored in the cloud resource usage cost management apparatus 112.

In another example, the cloud resource usage cost management apparatus 112 may be a hardware component, such as a chip, an integrated circuit, etc., and the modules 210-224 may be hardware modules on the hardware component. In a further example, the modules 210-224 may include a combination of software and hardware modules. In a yet further example, the processor 202 may be an ASIC that is to perform the functions of the modules 210-224. In this example, the processor 202 and the cloud resource usage cost management apparatus 112 may be a single processing apparatus.

The processor 202 may store data in the data store 206 and may use the data in implementing the modules 210-224. For instance, the processor 202 may store usage and utilization history of the entity 110, pricing plans of a cloud computing services provider 130, etc. In any regard, the data store 206 may be volatile and/or non-volatile memory, such as DRAM, EEPROM, MRAM, phase change RAM (PCRAM), memristor, flash memory, and the like. In addition, or alternatively, the data store 206 may be a device that may read from and write to a removable media, such as, a floppy disk, a CD-ROM, a DVD-ROM, or other optical or magnetic media.

The interface 204 may include hardware and/or software to enable the processor 202 to communicate with other devices (not shown) over a network 230. The interface 204 may enable a wired or wireless connection to the network 230, which may be any of a local area network, the Internet, etc. The interface 204 may include a network interface card and/or may also include hardware and/or software to enable the processor 202 to communicate with various input and/or output devices, such as a keyboard, a mouse, a display, another computing device, etc., through which a user may input instructions into the computing device 200.

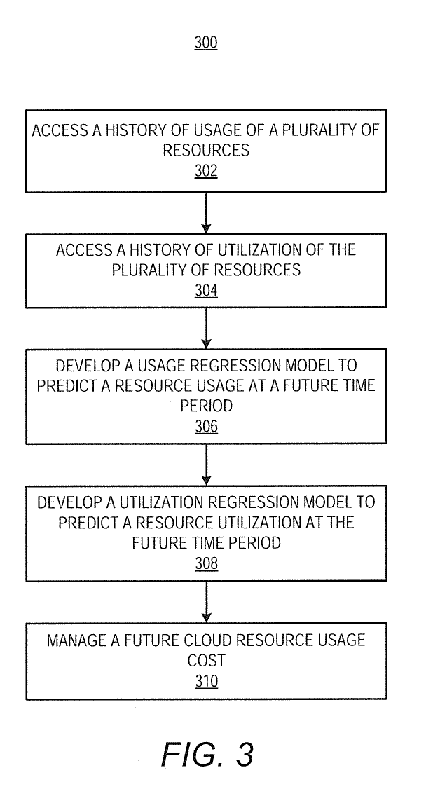

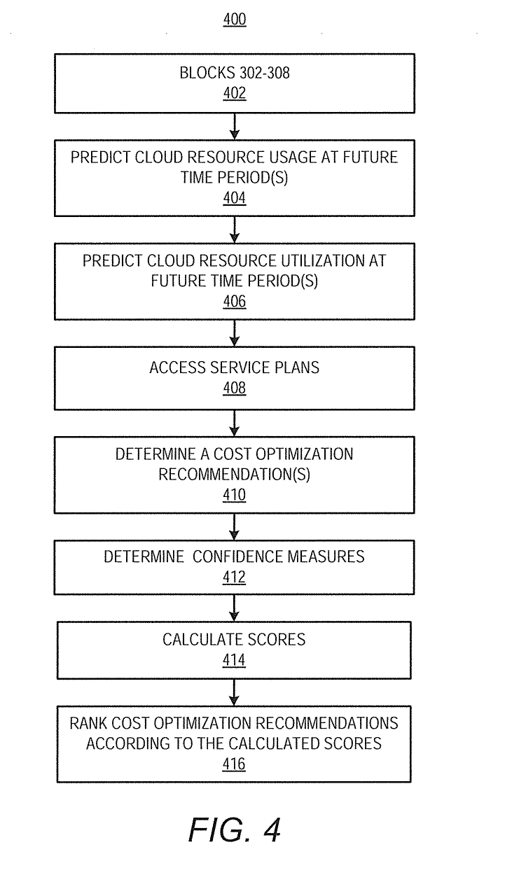

Various manners in which the processor 202 in general, and the modules 210-224 in particular, may be implemented are discussed in greater detail with respect to the methods 300 and 400 respectively depicted in FIGS. 3 and 4. Particularly, FIGS. 3 and 4 depict flow diagrams of methods 300 and 400 for future cloud resource usage cost management, according to two examples. It should be apparent to those of ordinary skill in the art that the methods 300 and 400 may represent generalized illustrations and that other operations may be added or existing operations may be removed, modified, or rearranged without departing from the scopes of the methods 300 and 400. Generally speaking, the processor 202 depicted in FIG. 2 may implement the methods 300 and 400 through implementation of at least some of the modules 210-224.

The descriptions of the methods 300 and 400are made with reference to the cloud resource usage cost management apparatus 112 illustrated in FIGS. 1 and 2 for purposes of illustration. It should, however, be clearly understood that apparatuses having other configurations may be implemented to perform the methods 300 and 400 without departing from the scopes of the methods 300 and 400.

With reference first to the method 300 depicted in FIG. 3, at block 302, a history of usage of a plurality of resources may be accessed, for instance, by the usage history accessing module 210. The plurality of resources may be the cloud resources 132 provided by a cloud computing services provider 130 and used by the entity 110. In other examples, the plurality of resources may be resources of the entity 110 or resources that the entity 110 receives from another provider. In any regard, the history of usage by the entity 110 of a plurality of resources may be a history of the number and type of resources that the entity, 110 has used over a particular period of time. The particular period of time may be any suitable length of time over which the history of the resource usage is to be tracked, for instance, a day, multiple days, a month, a year, etc. In one example, the usage history accessing module 210 may access the usage history by directly or indirectly collecting the resource usages by the entity 110. In another example, the usage history may be tracked by a product (not shown) that is external to the cloud resource usage cost management apparatus 112 and the usage history accessing module 210 may access the usage history from the external product. The external product may be a commercially available product that is to track usage history.

At block 304, a history of utilization of the plurality of resources may be accessed, for instance, by the utilization history accessing module 212. The utilization of the plurality of resources may be utilization levels of the cloud resources 132 by the entity 110 provided by a cloud computing services provider 130. In other examples, the utilization of the plurality of resources may be utilization levels of resources of the entity 110 or utilization levels of resources from another provider. The history of utilization of the plurality of resources may be a history of the percentage of the resources that the entity 110 has utilized over a particular period of time, e.g., percentage of the capacity available by a resource. By way of particular example in which the resource is a server machine, the utilization history of the resource may be the CPU utilization of the server machine over a particular period of time. That is, the utilization history may be the percentage of the total capacity of the server machine used by the entity 110 over the particular period of time. As another example in which the resource is a hard drive, the utilization history of the resource may be amount of disk space utilized over a particular period of time. In one regard, the utilization of the resources differs from the usage of the resources in that the usage of the resources may pertain to the number or amount of resources that are used and the utilization of the resources may pertain to the percentages of the total capacities of the resources that are utilized.

The particular period of time over which the history of utilization is accessed may be the same as the period of time over which the usage history is accessed. In one example, the utilization history accessing module 212 may access the utilization history by directly or indirectly collecting the resource utilizations by the entity 110. In another example, the usage history may be tracked by a product (not shown) that is external to the cloud resource usage cost management apparatus 112 and the usage history accessing module 210 may access the usage history from the external product. The external product may be a commercially available product that is to track utilization history.

Data regarding current and past resource usage may pertain to, for instance, the number and type of machines used, the network bandwidth used, the number of I/O calls, the amount of storage used, etc. In addition data regarding current and past resource utilization may pertain to, for instance, utilization metrics over time, such as CPU utilization, I/O utilization, storage utilization, etc.

At block 306, a regression model that is to predict a cloud resource usage at a future time period may be developed, for instance, by the usage regression model developing module 214. The usage regression model developing module 214 may develop the usage regression model based upon the history of usage accessed at block 302. Particularly, the usage regression model developing module 214 may take the history of usage data and may transform that data into a set of attributes that may be used as input to a machine learning predictor for any of the cloud resources provided by a cloud computing services provider 130. The attributes may include, for instance, relevant usages, a weekend usage attribute, sliding window averages of usage of each resource up to the time of the last measurement, etc. The usage regression model developing module 214 may also normalize the attributes. In addition, as the history of usage data (or equivalently the training sample set) may be relatively small, for instance, each instance may be the usage of one day, the usage regression model developing module 214 may apply principle component analysis (PCA) to the history of usage data for dimensionality reduction. The usage regression model developing module 214 may use the attributes to train predictors, such as support vector machine (SVM) regression predictors, multivariate linear regression predictors, etc., which may develop the usage regression model.

According to an example, the usage regression model developing module 214 may train the predictors for multiple future time periods, for instance, ranging from anywhere between 1 day to one year. The usage regression model developing module 214 may thus predict cloud resource usages by the entity 110 at one or a plurality of future time periods.

At block 308, a regression model that predicts a resource utilization at the future time period may be developed, for instance, by the utilization regression model developing module 216. The utilization regression model developing module 216 may develop the utilization regression model based upon the history of utilization accessed at block 304. Particularly, the utilization regression model developing module 216 may take the history of utilization data and may transform that data into a set of attributes that may be used as input to a machine learning predictor for any of the resources provided by a cloud computing services provider 130. The attributes may include utilization variables/resource pairs for the plurality of cloud resources utilized by the entity 110. By way of example in which the resources are server machines, the utilization variables may be the CPU utilization levels of the server machines over a period of time, e.g., one day.

The utilization regression model developing module 216 may also normalize the attributes. In addition, as the history of utilization data (or equivalently the training sample set) may be relatively small, for instance, each instance may be the utilization variable/resource of one day, the utilization regression model developing module 216 may apply principle component analysis (PCA) to the history of utilization data for dimensionality reduction. The utilization regression model developing module 216 may use the attributes to train predictors, such as support vector machine (SVM) regression predictors, multivariate linear regression predictors, etc., which may develop the utilization regression model.

According to an example, the utilization regression model developing module 216 may train the predictors for multiple future time periods, for instance, ranging from anywhere between 1 day to one year. The utilization regression model developing module 216 may thus predict cloud resource utilizations by the entity 110 at one or a plurality of future time periods. In addition, the utilization regression model developing module 216 may use a baseline with trend analysis to create the prediction of the resource utilizations. That is, the utilization regression model developing module 216 may develop the utilization regression model through learning from a multiple number of features/inputs, such as numeric values. Some of those features may be time related, such as day of year, week of year, month, etc. In addition, some of those values may be part of the data while other ones of those values may be extracted from other values, e.g., date, unix time, etc. The utilization regression model developing module 216 may use the time-related features to develop the utilization regression model and thus, the utilization regression model may create a trend based on the time-related features, such as month, day of year, etc. The usage regression model developing module 214 may also develop the usage regression model to create a trend based on time-related features for similar reasons.

Thus, for instance, the utilization regression model may be used to predict that utilization of a particular resource at a particular period of time, e.g., a particular week, will likely be higher than other time periods. Similarly, the usage regression model may be used to predict that the usage of a particular resource at a particular period of time, e.g., a particular month, will likely be lower than other time periods.

At block 310, a future cloud resource usage cost may be managed based upon the usage regression model and the utilization regression model, for instance, by the resource usage cost management module 218. As such, the resource usage cost management module 218 may manage the future cloud resource usage cost based upon the trends predicted through use of the utilization regression model and the usage regression model. For instance, if the utilization of a number of resources at a future period of time is predicted to be relatively low, the resource usage cost management module 218 may manage the future cloud resource usage by determining a minimum usage of the number of cloud resources, while maximizing utilization of the cloud resources. In this example, the cost for the predicted number of cloud resources required may be minimized by minimizing the reserved number of cloud resources. In contrast, if the utilization is predicted to be too high, e.g., more than the capacities of the predicted usage of cloud resources, then the predicted usage may be increased to provide sufficient capacity for the predicted utilization.

Through implementation of the method 300, the cloud resource usage and the cloud resource utilization, for instance, of an entity 110, may be predicted for a future time period or for future time periods. The predicted cloud resource usage and the predicted cloud resource utilization may become less accurate the further into the future that these predictions are made. As described in detail below with respect to the method 400 in FIG. 4, confidence measures for the predicted cloud resource usage(s) and the predicted cloud resource utilization(s) at the future time period or the future time periods may be determined. In addition, scores corresponding to the determined confidence measures may be determined and the scores may be ranked such that a user may identify, for instance, a predicted cloud resource usage and predicted cloud resource utilization having acceptable levels of accuracy at a future time period.

Turning now to FIG. 4, at block 402, blocks 302-308 in method 300 depicted in FIG. 3, may be performed to develop the usage regression model and the utilization regression model. At block 404, a cloud resource usage at the future time period or time periods may be predicted based upon the usage regression model. For instance, the resource usage cost management module 218 may predict the cloud resource usage at the future time period or time periods through application of the usage regression model developed at block 306. In other words, the resource usage cost management module 218 may predict the cloud resource usage at a future time period based upon the prediction made for that future time period by the usage regression model. As another example, the resource usage cost management module 218 may predict multiple cloud resource usages at a plurality of future time periods based upon the predictions made for those future time periods by a plurality of usage regression models.

At block 406, a cloud resource utilization at the future time or the future times may be predicted based upon the utilization regression model. For instance, the resource usage cost management module 218 may predict the cloud resource utilization at the future time period or time periods through application of the utilization regression model developed at block 308. In other words, the resource usage cost management module 218 may predict the cloud resource utilization at a future time period based upon the prediction made for that future time period by the utilization regression model. As another example, the resource usage cost management module 218 may predict multiple cloud resource utilizations at a plurality of future time periods based upon the predictions made for those future time periods by a plurality of utilization regression models.

At block 408, service plans of a cloud computing services provider 130 may be accessed. For instance, the resource usage cost management module 218 may access multiple service plans of the cloud computing services provider 130 or multiple providers. The service plans may identify the resources provided along with the costs associated with the providing of those resources. The service plans may also identify discounts for reservations of resources over periods of time.

At block 410, a cost optimization recommendation may be determined based upon the predicted cloud resource usage and the predicted cloud resource utilization at the future time period or at the multiple future time periods. For instance, in managing the future cloud resource usage cost, e.g., at block 310 in FIG. 3, the resource usage cost management module 218 may compare the accessed service plans of the cloud computing services provider 130 or providers and may determine the optimized, e.g., lowest, cost service plan for the entity 110 in using or reserving the cloud resources at the predicted levels. By way of example, it may more cost effective for the entity 110 to reserve a predicted amount of cloud resources at a particular time in the future as compared to another predicted amount of cloud resources at another time in the future. The resource usage cost management module 218 may output an indication of which option, e.g., an on-demand option, a reserved resources option, etc., may result in the least cost while meeting the predicted cloud resource requirements. A user may then determine from that indication which of the options to select in working with the cloud computing services provide 130 to obtain the predicted cloud resources. Thus, for instance, the resource usage cost management module 218 may recommend an order for an entity 110 for future cloud resource usage based upon the cost optimization recommendation that results in the lowest cost while meeting the entity's 110 predicted requirements.

According to an example, at block 410, the resource usage cost management module 218 may determine cost optimization recommendations for each of a plurality of predicted cloud resource usages and cloud resource utilizations at the multiple time periods. In this regard, the resource usage cost management module 218 may determine a different cost optimization recommendation for the multiple future time periods.

At block 412, confidence measures for each of the cost optimization recommendations may be determined. For instance, the confidence measure determining module 220 may determine a confidence measure for each of the cost optimization recommendations at the multiple future time periods. The confidence measures may be based upon the prediction accuracies of each of the cost optimization recommendations. The accuracies of the cost optimization recommendations may differ from each other, for instance, because the accuracies of the predictions may become lower the further in time the predictions are made.

According to an example, the confidence measures, and particularly, the accuracies of the cost optimization recommendations, may be determined through use of the training data. For instance, part of the history of usage may be used to train the usage regression models at the multiple future periods of time and another part of the history of usage may be used to test the accuracies of the usage regression models. The accuracies of the usage regression models may be determined according to how well the trained usage regression models match the test portion of the history of usage. The history of utilization may be used in similar manners to determine the accuracies of the utilization regression models.

At block 414, scores for each of the plurality of cost optimization recommendations at the multiple future time periods may be calculated. For instance, the score calculating module 222 may calculate the scores based upon the number of days in the future that the cost optimization recommendation has been made, the confidence measure of the resource usage prediction at the future time period, and the confidence measure of the resource utilization prediction at the future time period. By way of example, the score calculating module 222 may calculate the scores for each of the cost optimization recommendations using the following equation:

Score=(cost optimization recommendation/number of days ahead)*(1+confidence measure of the resource utilization prediction)*(1+confidence measure of the resource usage prediction).

By way of example in which the cost optimization recommendation for 3 days ahead is 100, the confidence measure of the resource utilization prediction is 0.6, and the confidence measure of the resource usage prediction is 0.1, then the score is (100/3)*1.6*1.1, which is 58.67.

At block 416, the cost optimization recommendations may be ranked according to the calculated scores. For instance, the ranking module 224 may rank the cost optimization recommendations at the multiple time periods according to their respective scores, e.g., with the highest ranking cost optimization recommendation at the top and the lowest ranking cost optimization at the bottom of the ranking. Thus, for instance, the highest ranking cost optimization recommendation may be recommended for ordering by an entity 110.

The ranking of the cost optimization recommendations may be outputted to a user and the user may select which of the cost optimization recommendations to select for their future resource usage supplied by a cloud computing services provider 130.

According to an example, at block 410, the cost optimization recommendations may be based upon the pricing plans of multiple cloud computing services providers. In this example, the resource usage cost management module 218 may access pricing plans from multiple cloud computing services providers. In addition, therefore, the scores calculated at block 414 may pertain to scores of cost optimization recommendations for the multiple cloud computing services providers. As a further example, the scores may pertain to scores of cost optimization recommendations that span across multiple ones of the cloud computing services providers.

Some or all of the operations set forth in the methods 300 and 400 may be contained as utilities, programs, or subprograms, in any desired computer accessible medium. In addition, the methods 300 and 400 may be embodied by computer programs, which may exist in a variety of forms both active and inactive. For example, they may exist as machine readable instructions, including source code, object code, executable code or other formats. Any of the above may be embodied on a non-transitory computer-readable storage medium.

Examples of non-transitory computer-readable storage media include computer system RAM, ROM, EPROM, EEPROM, and magnetic or optical disks or tapes. It is therefore to be understood that any electronic device capable of executing the above-described functions may perform those functions enumerated above.

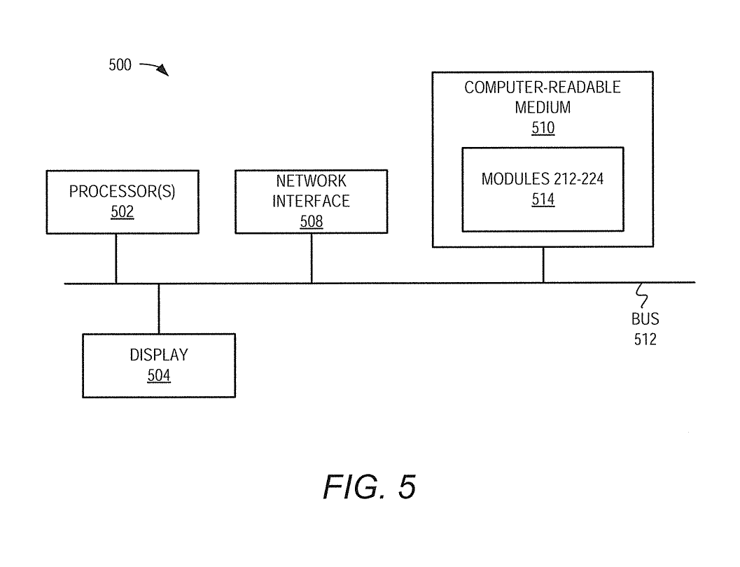

Turning now to FIG. 5, there is shown a schematic representation of a computing device 500, which may be employed to perform various functions of the computing device 200 depicted in FIG. 2, according to an example. The computing device 500 may include a processor 502, a display 504, such as a monitor; a network interface 508, such as a Local Area Network LAN, a wireless 802.11x LAN, a 3G mobile WAN or a WiMax WAN; and a computer-readable medium 510. Each of these components may be operatively coupled to a bus 512. For example, the bus 512 may be an EISA, a PCI, a USB, a FireWire, a NuBus, or a PDS.

The computer-readable medium 510 may be any suitable medium that participates in providing instructions to the processor 502 for execution. For example, the computer-readable medium 510 may be non-volatile media, such as an optical or a magnetic disk; volatile media, such as memory. The computer-readable medium 510 may also store a table processing machine readable instructions 514, which may perform the methods 300 and/or 400 and may include the modules 210-224 of the cloud resource usage cost management apparatus 112 depicted in FIG. 2. In this regard, the machine readable instructions 514 may include a usage history accessing module 210, a utilization history accessing module 212, a usage regression model developing module 214, a utilization regression model developing module 216, a resource usage cost management module 218, a confidence measure determining module 220, a score calculating module 222, and a ranking module 224.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A method for future cloud resource usage cost management, said method comprising:
accessing a history of usage of a plurality of resources;
accessing a history of utilization of the plurality of resources;
developing, by a processor and based upon the history of usage, a usage regression model to predict a cloud resource usage at a future time period;
developing, by the processor and based upon the history of utilization, a utilization regression model to predict a cloud resource utilization for each of a plurality of utilization variable/resource pairs at the future time period; and
managing a future cloud resource usage cost based upon the usage regression model and the utilization regression model.

2. The method according to claim 1, further comprising:
predicting a cloud resource usage at the future time period based upon the usage regression model;
predicting a cloud resource utilization at the future time period based upon the utilization regression model;
wherein managing the future cloud resource usage cost further comprises determining a cost optimization recommendation based upon the predicted cloud resource usage and the predicted cloud resource utilization at the future time period.

3. The method according to claim 2, wherein determining the cost optimization recommendation further comprises determining the cost optimization recommendation to be a reservation of resources from a cloud computing service provider for the predicted cloud resource usage at the future time period that results in a minimized cost for the predicted cloud resource usage.

4. The method according to claim 1, further comprising:
developing, by the processor, a plurality of usage regression models that each predicts a cloud resource usage at a plurality of future time periods; and
developing, by the processor, a plurality of utilization regression models that each predicts a cloud resource utilization for each of a plurality of utilization variable/resource pairs at the plurality of future time periods.

5. The method according to claim 4, further comprising:
predicting a cloud resource usage at each of the plurality of future time periods based upon the usage regression model at a respective one of the plurality of future time periods;
predicting a cloud resource utilization at each of the plurality of future time periods based upon the utilization regression model at a respective one of the plurality of future time periods; and
wherein managing the future cloud resource usage cost further comprises determining a cost optimization recommendation for each of the plurality of future time periods based upon the predicted cloud resource usage and the predicted cloud resource utilization at each of the plurality of future time periods.

6. The method according to claim 5, further comprising:
determining a confidence measure for each of the cost optimization recommendations at the plurality of future time periods.

7. The method according to claim 6, further comprising:
calculating respective scores for each of the cost optimization recommendations at the plurality of future time periods based upon the confidence measures for each of the plurality of future time periods; and
ranking the cost optimization recommendations according to the calculated scores.

8. The method according to claim 5, wherein determining the cost optimization recommendations for each of the plurality of future time periods further comprises determining the cost optimization recommendations to each be a reservation of resources from a cloud computing service provider for the predicted cloud resource usage and the predicted cloud resource utilization at each of the plurality of future time periods.

9. An apparatus for recommending an order for future cloud resource usage, said apparatus comprising:
a processor; and
a memory on which is stored machine readable instructions to cause the processor to:
access a history of usage and a history of utilization of a plurality of resources;
develop, based upon the history of usage, a usage regression model;
develop, based upon the history of utilization, a utilization regression model;
predict a cloud resource usage at a future time period based upon the usage regression model;
predict a cloud resource utilization for each of a plurality of utilization variable/resource pairs at the future time period based upon the utilization regression model; and
recommend the order for future cloud resource usage based upon the predicted cloud resource usage and the predicted cloud resource utilization, wherein the order recommendation is a recommendation for usage of cloud resources supplied by a cloud computing services provider at the future time period.

10. The apparatus according to claim 9, wherein the machine readable instructions are further to cause the processor to:
develop a plurality of usage regression models that each predicts a cloud resource usage at a plurality of future time periods; and
develop a plurality of utilization regression models that each predicts a cloud resource utilization for each of a utilization variable/resource pair at the plurality of future time periods.

11. The apparatus according to claim 10, wherein the machine readable instructions are further to cause the processor to:
predict a cloud resource usage at each of the plurality of future time periods based upon the usage regression model at a respective one of the plurality of future time periods;
predict a cloud resource utilization at each of the plurality of future time periods based upon the utilization regression model at a respective one of the plurality of future time periods; and
wherein, to recommend the order, the instructions are further to cause the processor to determine respective costs corresponding to the predictions at each of the plurality of future time periods, and to determine the order for future cloud resource usage to be the order that corresponds to the lowest cost.

12. The apparatus according to claim 11, wherein the machine readable instructions are further to cause the processor to:
determine a respective confidence measure for each of the resource usage and resource utilization predictions at the plurality of future time periods.

13. The apparatus according to claim 12, wherein the machine readable instructions are further to cause the processor to:
calculate respective scores for each of the resource usage and resource utilization predictions at the plurality of future time periods based upon the confidence measures for each of the plurality of future time periods; and
rank the cost optimization recommendations according to the calculated scores.

14. A non-transitory computer-readable storage medium on which is stored machine readable instructions that when executed by a processor cause the processor to:
access a history of usage of a history of utilization by an entity of a plurality of cloud resources;
develop, based upon the history of usage, a plurality of usage regression models;
develop, based upon the history of utilization, a plurality of utilization regression models;
predict cloud resource usages at a plurality of future time periods based upon the plurality of usage regression models;
predict cloud resource utilizations for each of a plurality of utilization variable/resource pairs at the plurality of future time periods based upon the plurality of utilization regression models; and
determine a cost optimization recommendation for the entity for each of the plurality of future time periods based upon the predicted cloud resource usages and the predicted cloud resource utilizations at the plurality of future time periods.

15. The non-transitory computer-readable storage medium according to claim 14, wherein the machine readable instructions are further to cause the processor to:
determine a respective confidence measure for each of the resource usage and resource utilization predictions at the plurality of future time periods;
calculate respective scores for each of the resource usage and resource utilization predictions at the plurality of future time periods based upon the confidence measures for each of the plurality of future time periods; and
rank the cost optimization recommendations according to the calculated scores.
